(19) United States
(12) Patent Application Publication
(10) Pub. No.: US 2018/0139328 A1
(43) Pub. Date: May 17, 2018

(54) SYSTEM AND METHOD FOR MANAGING CONTACT CENTER SYSTEM

(71) Applicant: INTERACTIVE INTELLIGENCE GROUP, INC., Indianapolis, IN (US)

(72) Inventors: William Anthony Alford, Raleigh, NC (US); Edward Dale Victor McCoy, Murfreesboro, TN (US)

(21) Appl. No.: 15/815,660

(22) Filed: Nov. 16, 2017

Related U.S. Application Data
(60) Provisional application No. 62/423,600, filed on Nov. 17, 2016.

(51) Int. Cl. H04M 3/523; G06F 15/18; G06Q 50/00

(52) U.S. Cl. CPC H04M 3/5233; H04M 3/5238; G06Q 50/01; H04M 3/5235; G06F 15/18

(57) ABSTRACT

In a method for managing a contact center, the method includes: receiving, by a processor, a first plurality of communications from a server during a training period; transmitting, by the processor, a pair of the communications to a device operated by a first contact center agent; receiving, by the processor, a signal from the device operated by the first contact center agent indicating a selection, by the first contact center agent, of a ranking between the pair of the communications; receiving, by the processor, a second plurality of communications from the server during a non-training period; reorganizing, by the processor, the second plurality of communications based on the selection of the ranking between the pair of communications to generate a reorganized second plurality of communications; and routing, by the processor during the non-training period, one or more of the reorganized second plurality of communications according to rank.

### CROSS-REFERENCE TO RELATED APPLICATION(S)

The present application claims priority to and the benefit of U.S. Provisional Patent Application No. 62/423,600, entitled “SYSTEM AND METHOD FOR RANKING UNITS OF WORK”, filed in the United States Patent and Trademark Office on Nov. 17, 2016, the entire content of which is incorporated herein by reference.

### FIELD

Aspects of embodiments of the present invention relate to a system and method for managing a contact center system.

### BACKGROUND

In order to remain competitive in the modern commerce system, many businesses remain constantly vigilant of evolving consumer demands, and strive to provide customers with the high quality products and services that they desire. To that end, many businesses employ contact centers that include automated systems and representatives of the business to process transactions and/or service the needs of their customers.

Such contact centers may utilize a number of communication channels to engage with customers, such as social media expressions and exchanges, telephone, email, live web chat, and the like. In many instances, an end user or customer may be contacted by, or routed to, a live human agent to assist the end user with his or her needs.

In some cases, companies may receive communications from customers via one or more third party social media platforms. Depending on the volume of communications from such third party social media platforms, and the resources of the business, it may be difficult to manage responses to customers in a timely and effective manner.

The above information discussed in this Background section is only for enhancement of understanding of the background of the described technology and therefore it may contain information that does not constitute prior art that is already known to a person having ordinary skill in the art.

### SUMMARY

Embodiments of the present invention are directed to systems and methods for managing a contact center system.

According to some example embodiments, in a method for managing a contact center, the method includes: receiving, by a processor, a first plurality of communications from a server during a training period; transmitting, by the processor, a pair of the communications to a device operated by a first contact center agent; receiving, by the processor, a signal from the device operated by the first contact center agent indicating a selection, by the first contact center agent, of a ranking between the pair of the communications; receiving, by the processor, a second plurality of communications from the server during a non-training period; reorganizing, by the processor, the second plurality of communications based on the selection of the ranking between the pair of communications to generate a reorganized second plurality of communications; and routing, by the processor during the non-training period, one or more of the reorganized second plurality of communications according to rank.

According to some example embodiments, the server corresponds to a social media platform.

According to some example embodiments, the method further includes storing, by the processor, the communications in a buffer.

According to some example embodiments, the method further includes storing, by the processor, the plurality of ranked pairs in a buffer based on a plurality of selections from a plurality of agents regarding a plurality of pairs of the communications.

According to some example embodiments, the signal comprises a ranked pair indicating the selection of the ranking between the pair of the communications.

According to some example embodiments, the method further includes calculating, by the processor, a weight vector based on the ranked pair.

According to some example embodiments, the method further includes reorganizing, by the processor, the second plurality of communications based on the weight vector.

According to some example embodiments, the method further includes routing, by the processor, a communication, from among the pair of communications, that corresponds to the selection of a higher ranking between the pair of the communications, to the device operated by the first contact center agent.

According to some example embodiments, the method further includes transmitting, by the processor, the pair of the communications to a device operated by a second contact center agent.

According to some example embodiments, the method further includes: receiving, by the processor, a signal from the device operated by the second contact center agent indicating a selection, by the second contact center agent, of the ranking between the pair of the communications; and overwriting, by the processor, the selection by the first contact center agent with the selection by the second contact center agent.

According to some example embodiments, in a system for managing a contact center, the system includes: a processor; and a memory coupled to the processor, wherein the memory stores instructions that, when executed by the processor, cause the processor to: receive a first plurality of communications from a server during a training period; transmit a pair of the communications to a device operated by a first contact center agent; receive a signal from the device operated by the first contact center agent indicating a selection, by the first contact center agent, of a ranking between the pair of the communications; receive a second plurality of communications from the server during a non-training period; reorganize the second plurality of communications based on the selection of the ranking between the pair of communications to generate a reorganized second plurality of communications; and route, during the non-training period, one or more of the reorganized second plurality of communications according to rank.

According to some example embodiments, the server corresponds to a social media platform.

According to some example embodiments, the instructions further cause the processor to store the communications in a buffer.

According to some example embodiments, the instructions further cause the processor to store the plurality of ranked pairs in a buffer based on a plurality of selections from a plurality of agents regarding a plurality of pairs of the communications.

According to some example embodiments, the signal comprises a ranked pair indicating the selection of the ranking between the pair of the communications.

According to some example embodiments, the instructions further cause the processor to calculate a weight vector based on the ranked pair.

According to some example embodiments, the instructions further cause the processor to reorganize the second plurality of communications based on the weight vector.

According to some example embodiments, the instructions further cause the processor to route a communication, from among the pair of communications, that corresponds to the selection of a higher ranking between the pair of the communications, to the device operated by the first contact center agent.

According to some example embodiments, the instructions further cause the processor to: transmit the pair of the communications to a device operated by a second contact center agent; receive a signal from the device operated by the second contact center agent indicating a selection, by the second contact center agent, of the ranking between the pair of the communications; and overwrite the selection by the first contact center agent with the selection by the second contact center agent.

According to some example embodiments, in a system for managing a contact center, the system includes: means for receiving a first plurality of communications from a server during a training period; means for transmitting a pair of the communications to a device operated by a first contact center agent; means for receiving a signal from the device operated by the first contact center agent indicating a selection, by the first contact center agent, of a ranking between the pair of the communications; means for receiving a second plurality of communications from the server during a non-training period; means for reorganizing the second plurality of communications based on the selection of the ranking between the pair of communications to generate a reorganized second plurality of communications; and means for routing, during the non-training period, one or more of the reorganized second plurality of communications according to rank.

### BRIEF DESCRIPTION OF THE DRAWINGS

A more complete appreciation of the present invention, and many of the attendant features and aspects thereof, will become more readily apparent as the invention becomes better understood by reference to the following detailed description when considered in conjunction with the accompanying drawings in which like reference symbols indicate like components, wherein:

FIG. 1 is a block diagram of a contact center management system according to some embodiments of the present invention;

FIG. 2A is a block diagram of illustrating further details of the contact center management system, according to some example embodiments of the present invention;

FIG. 2B is a block diagram of illustrating further details of the social media expression reorganization and control system during a non-training period, according to some example embodiments of the present invention;

FIG. 3 is a flow chart illustrating a process for training a contact center management system, according to some example embodiments of the present invention;

FIG. 4 is a flow chart illustrating a process for ranking and routing communications, according to some example embodiments of the present invention;

FIG. 5A is a block diagram of a computing device according to an embodiment of the present invention;

FIG. 5B is a block diagram of a computing device according to an embodiment of the present invention;

FIG. 5C is a block diagram of a computing device according to an embodiment of the present invention;

FIG. 5D is a block diagram of a computing device according to an embodiment of the present invention; and

FIG. 5E is a block diagram of a network environment including several computing devices according to an embodiment of the present invention.

### DETAILED DESCRIPTION

Aspects of the present invention are described with reference to one or more example embodiments in the following description with reference to the figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

Generally, modern contact centers are staffed with agents or employees who serve as an interface between an organization, such as a company, and outside entities, such as customers. For example, human sales agents at contact centers may assist customers in making purchasing decisions and may receive purchase orders from those customers. Similarly, human support agents at contact centers may assist customers in solving problems with products or services provided by the organization. Interactions between contact center agents and outside entities (customers) may be conducted by speech voice (e.g., telephone calls or voice over IP or VoIP calls), video (e.g., video conferencing), text (e.g., emails and text chat), or through other media.

In the modern commerce system, social media platforms have become a popular mechanism for customers to engage with businesses. For example, if a customer has complaints about the quality of products or services they receive from a business, the customer may utilize a third party social media platform (e.g., Facebook®, Twitter®, Snapchat®, LinkedIn®, YouTube®, etc., although embodiments of the present invention are not limited thereto) to send a message to, or about, the business. Many third party social media platforms provide a mechanism (e.g., a publically available application programming interface (API)) to enable businesses to receive a stream of social media communications or expressions that are targeted toward or mention the business.

The contact center system supporting a business may receive the stream of social media communications, and assign or route the communications to agents to analyzes the social media communications for providing customer support, feedback, comments, questions, etc. Such social media communications (also referred to herein as “expressions”) may be directed, for example, toward the operation, industry, product, customer service, system user, etc. With large volumes of social expressions, depending on the resources of the contact center, it may be difficult or impossible to address each social media expression. Because resources of the contact center are finite, responding to customers' social media expressions in the order that they are received may be less beneficial to businesses and customers alike. For example, the earliest-received social media expression may be less important to the interests of the business in terms of customer satisfaction, reputation, and profitability, than a social media expression received later. Embodiments of the present invention, provide a system and method to enable reordering and reorganization of social media expressions, in terms of when and whether the expressions are routed to agents for handling.

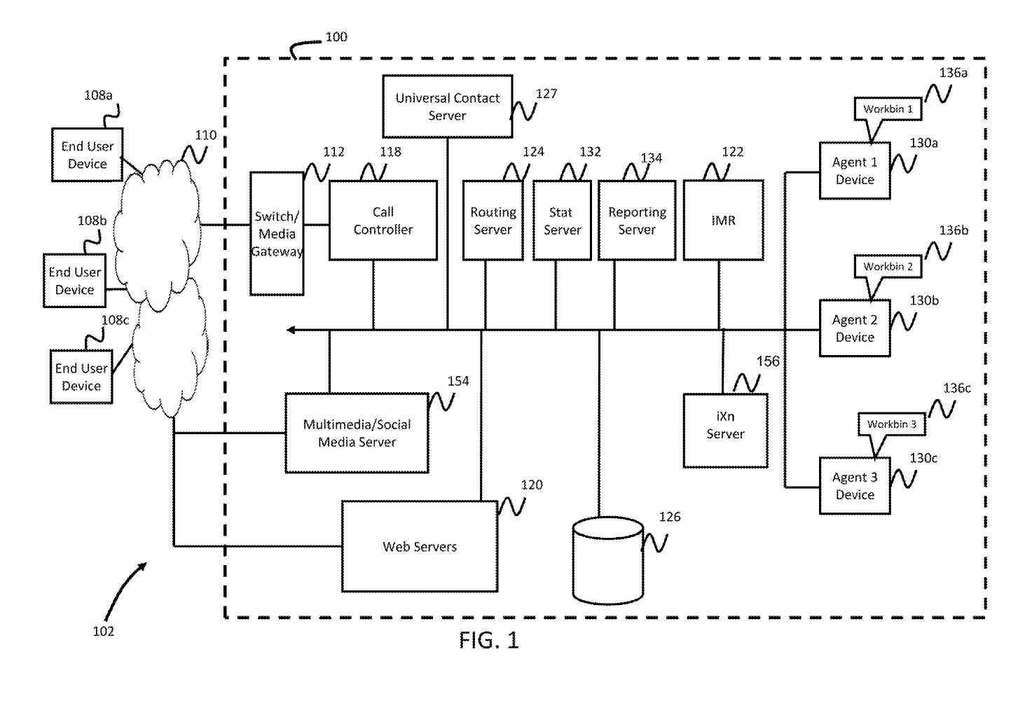

FIG. 1 is a schematic block diagram of a contact center system 100 operating as part of a social media expression reorganization and control system 102 for supporting a contact center in providing contact center services according to one example embodiment of the invention. The contact center may be an in-house facility to a business or enterprise for serving the enterprise in performing the functions of sales and service relative to the products and services available through the enterprise. In another aspect, the contact center may be operated by a third-party service provider. According to some embodiments, the contact center may operate as a hybrid system in which some components of the contact center system are hosted at the contact center premise and other components are hosted remotely (e.g., in a cloud-based environment). The contact center may be deployed in equipment dedicated to the enterprise or third-party service provider, and/or deployed in a remote computing environment such as, for example, a private or public cloud environment with infrastructure for supporting multiple contact centers for multiple enterprises. The various components of the contact center system may also be distributed across various geographic locations and computing environments and not necessarily contained in a single location, computing environment, or even computing device.

According to one example embodiment, the contact center system manages resources (e.g. personnel, computers, and telecommunication equipment) to enable delivery of services via telephone or other communication mechanisms. Such services may vary depending on the type of contact center, and may range from customer service to help desk, emergency response, telemarketing, order taking, and the like.

Customers, potential customers, or other end users (collectively referred to as customers or end users, e.g., end users) desiring to receive services from the contact center may initiate inbound communications (e.g., telephony calls) to the contact center via their end user devices 108a-108c (collectively referenced as 108). Each of the end user devices 108 may be a communication device conventional in the art, such as, for example, a telephone, wireless phone, smart phone, personal computer, electronic tablet, and/or the like. Users operating the end user devices 108 may initiate, manage, and respond to telephone calls, emails, chats, text messaging, web-browsing sessions, and other multi-media transactions.

Inbound and outbound communications from and to the end user devices 108 may traverse a telephone, cellular, and/or data communication network 110 depending on the type of device that is being used. For example, the communications network 110 may include a private or public switched telephone network (PSTN), local area network (LAN), private wide area network (WAN), and/or public wide area network such as, for example, the Internet. The communications network 110 may also include a wireless carrier network including a code division multiple access (CDMA) network, global system for mobile communications (GSM) network, or any wireless network/technology conventional in the art, including but to limited to 3G, 4G, LTE, and the like.

According to one example embodiment, the contact center system includes a switch/media gateway 112 coupled to the communications network 110 for receiving and transmitting telephony calls between end users and the contact center. The switch/media gateway 112 may include a telephony switch or communication switch configured to function as a central switch for agent level routing within the center. The switch may be a hardware switching system or a soft switch implemented via software. For example, the switch 112 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, an agent telephony or communication device. In this example, the switch/media gateway establishes a voice path/connection (not shown) between the calling customer and the agent telephony device, by establishing, for example, a connection between the customer's telephony device and the agent telephony device.

According to one exemplary embodiment of the invention, the switch is coupled to a call controller 118 which may, for example, serve as an adapter or interface between the switch and the remainder of the routing, monitoring, and other communication-handling components of the contact center.

The call controller 118 may be configured to process PSTN calls, VoIP calls, and the like. For example, the call controller 118 may be configured with computer-telephony integration (CTI) software for interfacing with the switch/media gateway and contact center equipment. In one embodiment, the call controller 118 may include a session initiation protocol (SIP) server for processing SIP calls. According to some exemplary embodiments, the call controller 118 may, for example, extract data about the customer interaction such as the caller's telephone number, often known as the automatic number identification (ANI) number, or the customer's internet protocol (IP) address, or email address, and communicate with other CC components in processing the interaction.

According to one exemplary embodiment of the invention, the system further includes an interactive media response (IMR) server 122, which may also be referred to as a self-help system, virtual assistant, or the like. The IMR server 122 may be similar to an interactive voice response (IVR) server, except that the IMR server 122 is not restricted to voice, but may cover a variety of media channels including voice. Taking voice as an example, however, the IMR server 122 may be configured with an IMR script for querying customers on their needs. For example, a contact center for a bank may tell customers, via the IMR script, to “press 1” if they wish to get an account balance. If this is the case, through continued interaction with the IMR server 122, customers may complete service without needing to speak with an agent. The IMR server 122 may also ask an open ended question such as, for example, “How can I help you?” and the customer may speak or otherwise enter a reason for contacting the contact center. The customer's response may then be used by a routing server 124 to route the call or communication to an appropriate contact center resource.

If the communication is to be routed to an agent, the call controller 118 interacts with the routing server (also referred to as an orchestration server) 124 to find an appropriate agent for processing the interaction. The selection of an appropriate agent for routing an inbound interaction may be based, for example, on a routing strategy employed by the routing server 124, and further based on information about agent availability, skills, and other routing parameters provided, for example, by a statistics server 132.

In some embodiments, the routing server 124 may query a customer database, which stores information about existing clients, such as contact information, service level agreement (SLA) requirements, nature of previous customer contacts and actions taken by contact center to resolve any customer issues, and the like. The database may be, for example, Cassandra or any NoSQL database, and may be stored in a mass storage device 126. The database may also be a SQL database and may be managed by any database management system such as, for example, Oracle, IBM DB2, Microsoft SQL server, Microsoft Access, PostgreSQL, MySQL, FoxPro, and SQLite. The routing server 124 may query the customer information from the customer database via an ANI or any other information collected by the IMR server 122.

Once an appropriate agent is identified as being available to handle a communication, a connection may be made between the customer and an agent device 130a-130c (collectively referenced as 130) of the identified agent. Collected information about the customer and/or the customer's historical information may also be provided to the agent device for aiding the agent in better servicing the communication. In this regard, each agent device 130 may include a telephone adapted for regular telephone calls, VoIP calls, and the like. The agent device 130 may also include a computer for communicating with one or more servers of the contact center and performing data processing associated with contact center operations, and for interfacing with customers via voice and other multimedia communication mechanisms.

The contact center system may also include a multimedia/social media server 154 for engaging in media interactions other than voice interactions with the end user devices 108 and/or web servers 120. The media interactions may be related, for example, to email, vmail (voice mail through email), chat, video, text-messaging, web, social media, co-browsing, and the like. In this regard, the multimedia/social media server 154 may take the form of any IP router conventional in the art with specialized hardware and software for receiving, processing, and forwarding multi-media events.

According to some example embodiments, the multimedia/social media server 154 may be configured to receive a stream of social media expressions, by way of a publicly accessible application programming interface (API), from one or more third-party or internal social media platforms (e.g., a server operated by or corresponding to the social media platforms). Thus, according to some example embodiments, as will be described in more detail below, the multimedia/social media server 154 may operate to facilitate communications between the contact center system (or agents of the contact center system) and customers who are engaged with third party or internal social media platforms. According to some embodiments, the multimedia/social media server 154 may include or be connected to a memory or buffer for storing social media expressions or communications (and/or information about social media expressions or communications, such as user profile information, communication content, user interaction history, and the like).

The web servers 120 may include, for example, social interaction site hosts for a variety of known social interaction sites to which an end user may subscribe, such as, for example, Facebook®, Twitter®, and the like. In this regard, although in the embodiment of FIG. 1 the web servers 120 are depicted as being part of the contact center system, the web servers may also be provided by third parties and/or maintained outside of the contact center premise. The web servers may also provide web pages for the enterprise that is being supported by the contact center. End users may browse the web pages and get information about the enterprise's products and services. The web pages may also provide a mechanism for contacting the contact center, via, for example, web chat, voice call, email, web real time communication (WebRTC), or the like.

According to one exemplary embodiment of the invention, in addition to real-time interactions, deferrable (also referred to as back-office or offline) interactions/activities may also be routed to the contact center agents. Such deferrable activities may include, for example, responding to emails, responding to letters, attending training seminars, or any other activity that does not entail real time communication with a customer. In this regard, an interaction (iXn) server 156 interacts with the routing server 124 for selecting an appropriate agent to handle the activity. Once assigned to an agent, an activity may be pushed to the agent, or may appear in the agent's workbin 136a-136c (collectively referenced as 136) as a task to be completed by the agent. The agent's workbin may be implemented via any data structure conventional in the art, such as, for example, a linked list, array, and/or the like. The workbin 136 may be maintained, for example, in buffer memory of each agent device 130.

According to one exemplary embodiment of the invention, the mass storage device(s) 126 may store one or more databases relating to agent data (e.g. agent profiles, schedules, etc.), customer data (e.g. customer profiles), interaction data (e.g. details of each interaction with a customer, including reason for the interaction, disposition data, time on hold, handle time, etc.), and the like. According to one embodiment, some of the data (e.g. customer profile data) may be maintained in a customer relations management (CRM) database hosted in the mass storage device 126 or elsewhere. The mass storage device may take form of a hard disk or disk array as is conventional in the art.

According to some embodiments, the contact center system may include a universal contact server (UCS) 127, configured to retrieve information stored in the CRM database and direct information to be stored in the CRM database. The UCS 127 may also be configured to facilitate maintaining a history of customers' preferences and interaction history, and to capture and store data regarding comments from agents, customer communication history, and the like.

The contact center system may also include a reporting server 134 configured to generate reports from data aggregated by the statistics server 132. Such reports may include near real-time reports or historical reports concerning the state of resources, such as, for example, average waiting time, abandonment rate, agent occupancy, and the like. The reports may be generated automatically or in response to specific requests from a requestor (e.g. agent/administrator, contact center application, and/or the like).

The various servers of FIG. 1 may each include one or more processors executing computer program instructions and interacting with other system components for performing the various functionalities described herein. The computer program instructions are stored in a memory implemented using a standard memory device, such as, for example, a random access memory (RAM). The computer program instructions may also be stored in other non-transitory computer readable media such as, for example, a CD-ROM, flash drive, or the like. Also, although the functionality of each of the servers is described as being provided by the particular server, a person of skill in the art should recognize that the functionality of various servers may be combined or integrated into a single server, or the functionality of a particular server may be distributed across one or more other servers without departing from the scope of the embodiments of the present invention.

In the various embodiments, the terms “interaction” and “communication” are used interchangeably, and generally refer to any real-time and non-real time interaction that uses any communication channel including, without limitation, social media expressions or communications, telephony calls (PSTN or VoIP calls), emails, vmails (voice mail through email), video, chat, screen-sharing, text messages, social media messages, web real-time communication (e.g. WebRTC calls), and the like.

As discussed above, depending on the volume of social media expressions directed to a business, agents at a contact center supporting the business may not be able to address each expression. Accordingly, the business may benefit from reorganizing the order of such social media expressions according to the business interests of the business to enable the highest priority social media expressions to be addressed before lower priority social media expressions.

According to some example embodiments, the reorganizing of social media expressions prior to routing to agents may be accomplished by assigning a relative rank or score to each social expression based on how important the social expression is to the business interests of the business. According to some example embodiments, the contact center system may utilize a machine learning algorithm, discussed in more detail below, to enable organizations to reorganize social media expressions according to their unique business interests.

Reordering or ranking incoming social media expressions according to business interest priority, may enable businesses to save resources for responding to customers' needs while ensuring that the highest priority communications are addressed.

For example, according to some example embodiments, the contact center system 100 (e.g., by way of the multimedia/social media server 154) may receive a stream of social media expressions or communications (e.g., including dozens, hundreds, or thousands of social media expressions or communication messages) from one or more third party or internal social media platforms over a time interval (e.g., a predetermined time interval, such as one hour). The contact center system 100 (e.g., the multimedia/social media server 154) may then automatically reorganize or reorder the social media expressions received during the time interval according to the relative importance of each social media expression.

After reorganizing the social media expressions according to their relative importance or priority according to the business interests of the contact center, the contact center system 100 may then route the social media expressions to contact center agents according to the relative ranking or order of the social media expressions. Thus, rather than routing social media expressions to agents according to the time that such social media expressions are received (e.g., first-in-first-out), the contact center system 100 may enable routing and handling of the social media expressions according to business interest priority. Ranking of incoming social media expressions according to their relative priority or importance to business interests may enable the contact center to reduce or maintain relatively low overhead (e.g., by employing fewer agents) while ensuring that the highest priority social media expressions are routed to an agent for handling (e.g., responding to customer complaints and questions, fulfilling customer requests, etc.).

For example, in the context of a contact center that supports a business, the business may wish to ensure that high value or important customers are happy and that any of their concerns or questions are answered by an agent. In such instances, the business may be willing to accept that certain customers' concerns or questions may not be routed to an agent for handling. As another non-limiting example, if the contact center supports an organization such as a charity, political organization, or fundraising entity, the organization may wish to ensure that larger donors' communications are prioritized over those of smaller donors.

According to some example embodiments, the social media expression reorganization and control system 102 may utilize a machine learning algorithm to facilitate automatic reorganization or re-ranking of social media expressions. The machine learning algorithm may utilize periodic or occasional training periods interspersed between non-training periods.

Table 1, below, outlines operations of a machine learning algorithm for gathering training data for training the social media expression reorganization and control system 102 to reorganize a stream of social media expressions according to a business or organization's unique business interests.

TABLE 1

| | |
|---|---|
| 1. | Receive incoming stream of social media expressions from third party |
| | or internal social media platform. |
| 2. | Select two social media expressions and send to an agent to select |
| | which of the two social media expression is more important (or |
| | higher priority). |
| 3. | Receive selection from the agent, and store the pair of social media |
| | expression as a ranked pair. |
| 4. | Repeat operations 1 through 3 during a predetermined training period |
| | until the training period is over. |

After a training period is over, as indicated in Table 1, the social media expression reorganization and control system 102 proceeds to generates a weight vector based on the training data (e.g., as illustrated by the algorithm shown in Table 1). Table 2, below, outlines operations of a machine learning algorithm for a social media expression reorganization and control system 102 to generate a weight vector based on training data.

```
TABLE 2
1. Assume that the system has stored a plurality of ranked pairs from the algorithm
described with respect to Table 1, the ranked pairs collectively referred to as a training
set.
2. Utilize a support vector machine (SVM) for ranking social media expressions by
executing the following for each ranked pair of social media expressions in the training
set:
    Convert both social media expressions to a feature vector comprising a
    collection of numbers that represent various properties of the social media
    expression, such as follower count, number of instances of sharing of social
    media expressions, “bag of words”, user profile information, etc.
    For half of the pairs in the training set, take the feature vector for the higher-
    ranked social media expression and subtract the feature vector for the
    lower-ranked social media expression; call this subset A.
    For the other half of the pairs in the training set, take the feature vector for
    the lower-ranked social media expression and subtract the feature vector for
    the higher-ranked social media expression; call this subset B.
    Store the difference between the feature vectors as a vector difference.
    This vector difference is the input to the SVM classifier training algorithm.
    The difference vectors from subset A are treated as examples of the positive
    class. The difference vectors from subset B are treated as examples of the
    negative class.
3. Calculate a weight vector based on the difference vectors using any suitable training
algorithm known in the art (e.g., an SVM training algorithm), using the feature vectors
and/or the difference vectors from subset A and the feature vectors and/or the difference
vectors from subset B as the inputs to the algorithm, with the weight vector being the
output of the algorithm.
```

Once a weight vector is created based on the training data, the social media expression reorganization and control system 102 proceeds to ranking a new set of social media expressions, as illustrated in Table 3, below.

```
TABLE 3
1. Assume that the system has a weight vector from the algorithm illustrated in Table 2.
2. Receive and store a plurality of new incoming social media expressions during a
predetermined time period or until a predetermined number of social media expressions
are collected.
3. Once the predetermined time period is finished or the predetermined number of social
media expressions is reached, rank the stored social media expressions using the
following process:
    For each new stored social media expression, convert the social media
    expression to a feature vector as described with respect to Table 1.
    Calculate the absolute rank of each social media expression by performing a
    dot product of the feature vector and the weight vector obtained as
    described with respect to Table 2.
4. Sort or reorder each of the stored social media expressions according to their relative
absolute rank.
5. Route the reordered social media expressions to agents according to their order.
```

Further details about an example algorithm for ranking using an SVM training algorithm can be found in Optimizing Search Engines using Clickthrough Data, T. Joachims, KDD '02 Proceedings of the eighth ACM SIGKDD international conference on Knowledge discovery and data mining, pp. 133-142, incorporated herein by reference.

Thus, by executing the algorithms described in Tables 1-3, the social media expression reorganization and control system 102 is configured to reorganize incoming social media expressions according to their relative importance or priority for achieving the business interests of the organization, rather than according to the order in which they are received.

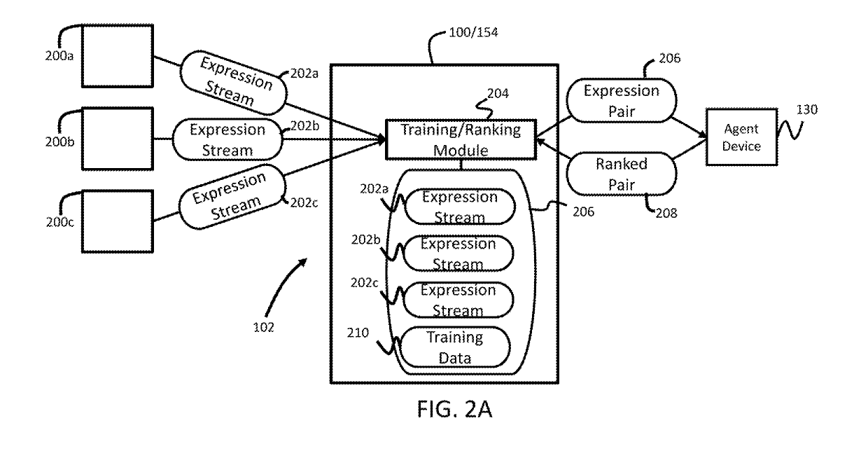

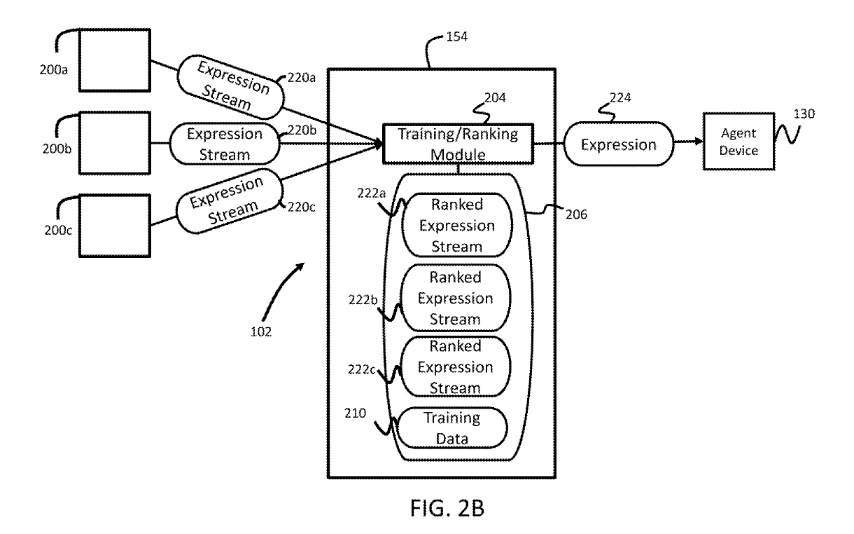

FIG. 2A is a block diagram of illustrating further details of the social media expression reorganization and control system 102 during a training period, according to some example embodiments of the present invention. As illustrated in FIG. 2A, the contact center system 100, operating as part of the social media expression reorganization and control system 102, may be in electronic communication with one or more third party (or internal) social media platforms 200a-200c (the number of social media platforms is not limited to the number illustrated in FIGS. 2A and 2B, and may include any suitable number and variety of social media platforms according to the design of the social media expression reorganization and control system 102). Although embodiments of the present invention are described with the multimedia/social media server 154 controlling the social media expression reorganization and routing to agents, embodiments of the present invention are not limited thereto, and various aspects or features may be executed by other elements or components of the contact center system 100.

As illustrated in FIG. 2A, the contact center system 100 and/or the multimedia/social media server 154 is configured to receive an expression or communication stream 202a-202c through each of the social media platforms 200a-200c, respectively, by way of a publicly available API. Each social media platform 200a-200c may have its own unique mechanism or protocol, but each provides a mechanism to allow the contact center system 100 and/or the multimedia/social media server 154 to “listen” to (e.g., receive) social media expressions that relate to the business or organization supported by the contact center system 100. For example, if a user of one of the social media platforms 200a-200c mentions the organization (by including a screen name or address associated with the organization in the social media expression) or a product or service provided by the organization, the social media platform may identify the social media expression as being relevant to the organization and transmit the social media expression to the contact center system 100 and/or the multimedia/social media server 154 as part of the expression stream. The particular mechanism or protocol for identifying and transmitting social media expressions from a social media platform to the contact center system 100 may vary according to the design and function of the social media platform and/or the contact center system 100.

In order to enable the social media expression reorganization and control system 102 to automatically reorganize a stream or group of social media expressions according to business interests of the organization, the social media expression reorganization and control system 102 periodically engages in a training period. The training period may be initiated periodically on a regular schedule (e.g., once a week, once a month, etc.), or may be initiated at any time by the organization, for example, due to a change or evolution in products, services, or business interests of the organization. By engaging in the training period, however, each organization that utilizes the social media expression reorganization and control system 102 may be enabled to prioritize incoming social media expressions according to their own unique business interests.

During the training period each expression stream 202a-202c is received by the contact center system 100 and/or the multimedia/social media server 154 and a training/ranking module 204 may facilitate storage of the expression streams 202a-202c in a buffer or memory 206. Additionally, the training/ranking module 204 (or an agent of the contact center) selects two of the expressions from one or more of the expression streams to be presented to an agent operating an agent device as an expression pair 206. The contact center system 100 and/or the multimedia/social media server 154 transmits the expression pair 206 to the agent device 130 for display thereby. For example, according to some example embodiments, the agent device 130 may be part of an agent workstation, and may include a display device configured to display a user interface for displaying the expression pair 206. According to some example embodiments, additional contextual information may also be transmitted for display along with the expression pair 206. For example, according to some embodiments, information about the user or customer (e.g., user profile information, interaction history, purchase history, demographic information, etc.) who transmitted or created the social media expression may be transmitted for display along with the expression pair 206.

The agent operating the agent device 130 selects whichever social media expression from among the pair of social media expressions that the agent perceives as more important than the other. The agent's perception or selection may be influenced or dictated by the unique business interests of the organization of which the agent is a member or employee. For example, if the organization desires to maintain customer satisfaction of a certain favored category of customers (e.g., high volume customers, customers of a target demographic, etc.), the organization may teach agents to select social media expressions from the favored category of customers. As another example, an organization may desire to have agents select whichever social media expression is associated with a customer or user who is more likely to purchase additional products or services. The particular rules or parameters that influence or dictate the selection of the agent may be unique to each organization, and may vary according to the business interests of the organization.

According to some example embodiments, the agent may also indicate as part of the selection, the particular feature or aspect of the selected social media expression that caused the agent to select the social media expression. For example, the agent may indicate, as part of the selection, that the agent selected the social media expression because the user who sent the social media expression has more followers, or mentioned a particular word or phrase that is relevant to the business interests of the organization. The agent's reason for selecting one social media expression over another may then be utilized as part of the training of the algorithm. For example, according to some example embodiments, the reason for the agent's selection may be incorporated into the feature vector and/or the difference vector corresponding to the ranked pair.

Upon selecting one of the social media expressions of the expression pair 206, the selected expression is then routed to the agent for normal handling. For example, the contact center system 100 and/or the agent operating the agent device 130 may initiate an outgoing communication to the user who sent the selected expression to resolve whatever issue or issues the user has raised. Thus, according to example embodiments of the present invention, the social media expression reorganization and control system 102 is configured to enable agents to handle interactions received during the training period without requiring that the training period be completed or that the machine learning algorithm of the social media expression reorganization and control system 102 is finished training.

Meanwhile, after the agent selects one of the social media expressions of the expression pair 206, the pair of social media expressions, along with information about the selected higher priority social media expression, is transmitted to the training/ranking module 204 and stored as training data 210 in the buffer/memory 206.

At the end of the predetermined training period (e.g., after a predetermined period if time has elapsed, or after a predetermined number of ranked pairs is received), the social media expression reorganization and control system 102 proceeds to a non-training period for automatically routing social media expressions to agents according to relative rank or importance. In particular, as described above with respect to Tables 1-3, the social media expression reorganization and control system 102 is configured to generate a weight vector based on the training data 210, and then re-rank or reorganize a group or stream of new social media expressions for routing to agents according to relative rank.

According to some example embodiments, the organization may wish to include a second layer of training in which supervising agents are presented with all or some of the same choices of expression pairs 206 as other agents were presented during the training period. For example, according to some embodiments, after the training period or during the training period, a second agent (e.g., a supervising agent) may be presented with a series of expression pairs 206 for selecting the higher priority or more important social expression. If the second agent's selection is different from the selection of the first agent, and the second agent has a higher level of authority (e.g., as a supervisor or manager), the social media expression reorganization and control system 102 may overwrite the ranked pair 208 and/or the training data 210 from the first agent. Additionally, according to some example embodiments, the social media expression reorganization and control system 102 may be configured to identify whether or not a particular agent's selections are different from those of a supervision agent, and disregard the particular agent's selections going forward by not storing ranked pairs or training data from that agent as part of the training process.

FIG. 2B is a block diagram of illustrating further details of the social media expression reorganization and control system 102 during a non-training period, according to some example embodiments of the present invention. As illustrated in FIG. 2B, during the non-training period, the contact center system and/or the multimedia/social media server 154 receives on or more new expressions streams 220a-200c from the one or more social media platforms 200a-200c. The training/ranking module 204 and/or the social media expression reorganization and control system 102 stores the expression streams 220a-220c (e.g., in the buffer/memory 206). After a predetermined period of time or a predetermined number of social media expressions are received, the training/ranking module 204 (and/or the social media expression reorganization and control system 102) reorganizes (e.g., using the algorithm described above respect to Table 3) the stored one or more expression streams 220a-220c to generate one or more ranked expression streams 222a-222c, respectively. According to various embodiments, the ranked expression streams 222a-222c may be stored as separate groups (e.g., corresponding to respective social media platforms), or may be consolidated into fewer groups (e.g., a single group) of social media expressions, that are ranked according to importance to the organization based on the automated ranking process described above.

After reorganizing the social media expressions into ranked expression streams 222a-222c, expressions 224 are transmitted to agent devices 130 operated by agents according to their rank, depending on agent availability and routing rules. That is, the highest ranked expressions are routed to agents first, and then, depending on agent availability, lower ranked expressions may be routed to agents.

According to some example embodiments, the social media expression reorganization and control system 102 may initiate a new non-training period after a predetermined period of time or after a predetermined number of the ranked expressions are handled. For example, in some instances, in the interest of preserving contact center resources and/or reducing agent burden, the organization may wish to only have a predetermined number of social media expressions routed to agents for a given non-training period before initiating a new non-training period or a new training period. Alternatively, the organization may wish to only route social media expressions to agents that are above a predetermined rank in the group of ranked social media expressions before initiating a new non-training period or a new training period. In some instances, the organization may only wish to route ranked social media expressions to agents for a predetermined period of time before initiating a new non-training period or a new training period.

Thus, according to some example embodiments, the social media expression reorganization and control system 102 may be configured to route ranked expressions to agents during a non-training period until a predetermined trigger event occurs (e.g., a predetermined number of ranked social media expressions are routed to agents, a predetermined period of time has elapsed, all ranked social media expressions above a predetermined rank threshold have been routed, etc.). In response to the predetermined trigger event occurring, the social media expression reorganization and control system 102 may then initiate a new non-training period (or a new training period, depending on the design of the social media expression reorganization and control system 102 or the desires of managing agents of the contact center). During the new non-training period, the social media expression reorganization and control system 102 may proceed to receive one or more streams of new social media expressions from one ore more social media platforms, which are then reorganized or re-ranked as discussed above, prior to routing to agents for handling.

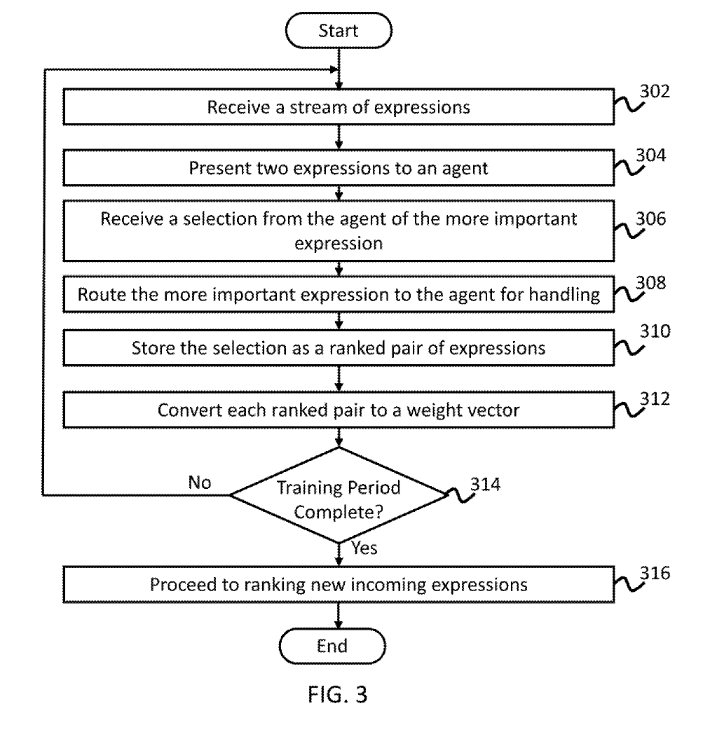

FIG. 3 is a flow chart illustrating a process for training a contact center management system during a training period, according to some example embodiments of the present invention. The number and order of the operations illustrated in FIG. 3 may vary depending on the design of the social media expression reorganization and control system 102. For example, additional or fewer operations may be included, and the order of the operations may vary, unless otherwise stated expressly or implicitly.

The process starts and, at 302, the system receives a stream of social media expressions or communications for one or more social media platforms. The stream of social media expressions are stored in a memory or buffer. Then, at 304, social media expressions are presented to an agent, two at a time, as a pair of social media expressions. At 306, the system receives a selection from the agent regarding the higher priority or more important social media expression from the pair of social media expressions. At 308, the selected higher priority or more important social media expression is then routed to the agent for handling according to normal routing and handling rules. Additionally, at 310, the agent's selection is stored in memory as a ranked pair of expressions. At 312, the ranked pair is converted to a weight vector (e.g., as discussed above with respect to Tables 1 and 2. At 314, the system determines whether or not the training period is complete, and if not, the system returns to operation 302. If, at 314, the system determines the training period is complete, the system proceeds, at 316, to rank a new batch or group of incoming social media expressions during a non-training period based on the weight vector.

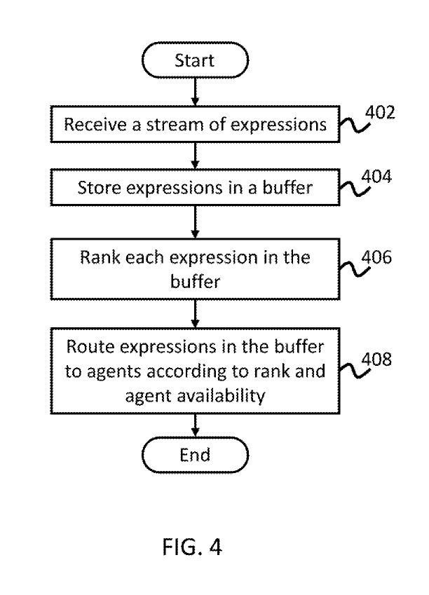

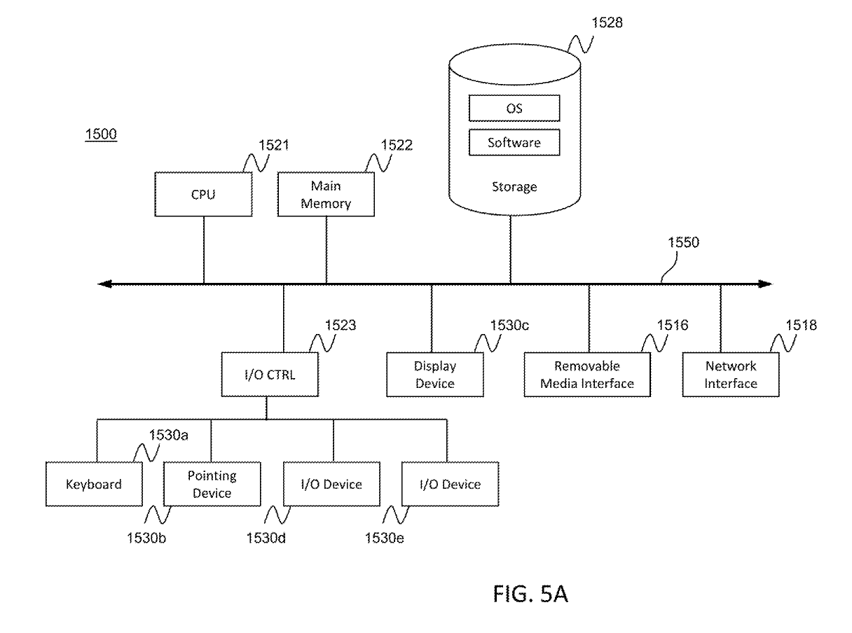

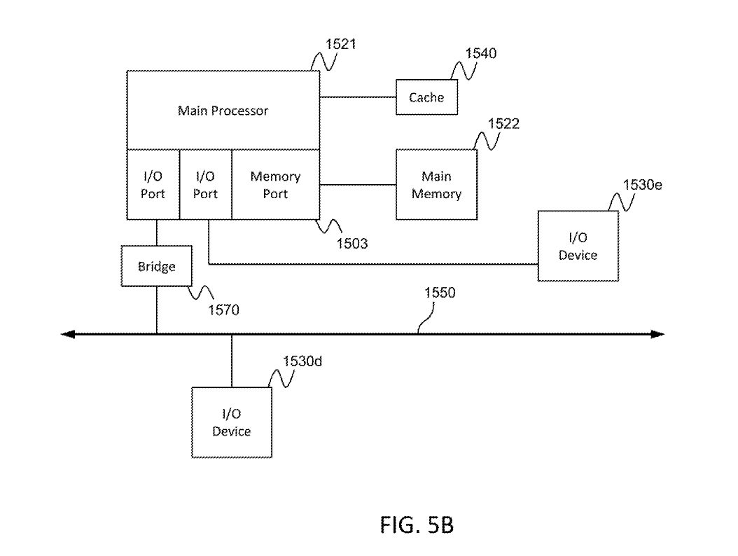

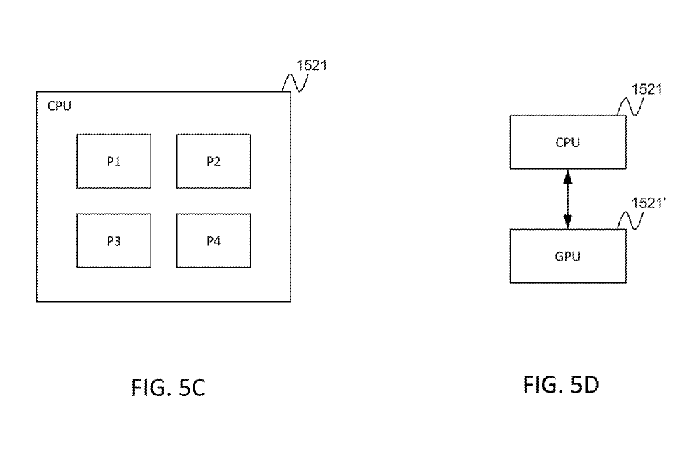

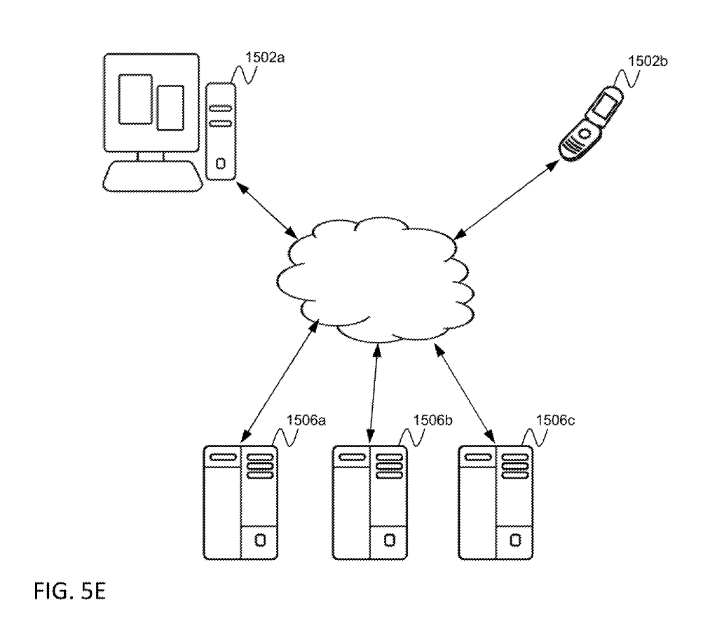

FIG. 4 is a flow chart illustrating a process for ranking and routing communications, according to some example embodiments of the present invention. The number and order of the operations illustrated in FIG. 4 may vary depending on the design of the social media expression reorganization and control system 102. For example, additional or fewer operations may be included, and the order of the operations may vary, unless otherwise stated expressly or implicitly.

The process starts and, at 402, the system receives a stream of social media expressions or communications from one or more social media platforms. The social media expressions are stored in a buffer at 404. Then, after a predetermined period of time, or after a predetermined number of social media expressions are received, the system proceeds, at 406, to reorder or re-rank the social media expressions according to priority or importance (e.g., using the algorithm described above, for example, with respect to Table 3). Then, at 408, the system routes the expressions to agents according to the rank of the expressions, agent availability, and any other routing or business rules for routing social media expressions to agents.

Thus, as described above, embodiments of the present invention enable receiving social media expressions from one or more social media platforms, and routing the social media expressions to agents according to their relative importance or priority. Instead of merely chronologically routing messages from social media platforms to agents for handling based on the order in which they are received, embodiments of the present invention enable reprioritizing or reorganizing of social media expressions in batches according to the business interests of the organization.

In one embodiment, each of the various servers, controllers, switches, gateways, engines, and/or modules (collectively referred to as servers) in the afore-described figures are implemented via hardware or firmware (e.g. ASIC) as will be appreciated by a person of skill in the art.

In one embodiment, each of the various servers, controllers, engines, and/or modules (collectively referred to as servers) in the afore-described figures may be a process or thread, running on one or more processors, in one or more computing devices 1500 (e.g., FIG. 50A, FIG. 50B), executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that a computing device may be implemented via firmware (e.g. an application-specific integrated circuit), hardware, or a combination of software, firmware, and hardware. A person of skill in the art should also recognize that the functionality of various computing devices may be combined or integrated into a single computing device, or the functionality of a particular computing device may be distributed across one or more other computing devices without departing from the scope of the exemplary embodiments of the present invention. A server may be a software module, which may also simply be referred to as a module. The set of modules in the contact center may include servers, and other modules.

The various servers may be located on a computing device on-site at the same physical location as the agents of the contact center or may be located off-site (or in the cloud) in a geographically different location, e.g., in a remote data center, connected to the contact center via a network such as the Internet. In addition, some of the servers may be located in a computing device on-site at the contact center while others may be located in a computing device off-site, or servers providing redundant functionality may be provided both via on-site and off-site computing devices to provide greater fault tolerance. In some embodiments of the present invention, functionality provided by servers located on computing devices off-site may be accessed and provided over a virtual private network (VPN) as if such servers were on-site, or the functionality may be provided using a software as a service (SaaS) to provide functionality over the internet using various protocols, such as by exchanging data using encoded in extensible markup language (XML) or JavaScript Object notation (JSON).

FIG. 50A and FIG. 50B depict block diagrams of a computing device 1500 as may be employed in exemplary embodiments of the present invention. Each computing device 1500 includes a central processing unit 1521 and a main memory unit 1522. As shown in FIG. 50A, the computing device 1500 may also include a storage device 1528, a removable media interface 1516, a network interface 1518, an input/output (I/O) controller 1523, one or more display devices 1530c, a keyboard 1530a and a pointing device 1530b, such as a mouse. The storage device 1528 may include, without limitation, storage for an operating system and software. As shown in FIG. 50B, each computing device 1500 may also include additional optional elements, such as a memory port 1503, a bridge 1570, one or more additional input/output devices 1530d, 1530e and a cache memory 1540 in communication with the central processing unit 1521. The input/output devices 1530a, 1530b, 1530d, and 1530e may collectively be referred to herein using reference numeral 1530.

The central processing unit 1521 is any logic circuitry that responds to and processes instructions fetched from the main memory unit 1522. It may be implemented, for example, in an integrated circuit, in the form of a microprocessor, microcontroller, or graphics processing unit (GPU), or in a field-programmable gate array (FPGA) or application-specific integrated circuit (ASIC). The main memory unit 1522 may be one or more memory chips capable of storing data and allowing any storage location to be directly accessed by the central processing unit 1521. As shown in FIG. 50A, the central processing unit 1521 communicates with the main memory 1522 via a system bus 1550. As shown in FIG. 50B, the central processing unit 1521 may also communicate directly with the main memory 1522 via a memory port 1503.

FIG. 50B depicts an embodiment in which the central processing unit 1521 communicates directly with cache memory 1540 via a secondary bus, sometimes referred to as a backside bus. In other embodiments, the central processing unit 1521 communicates with the cache memory 1540 using the system bus 1550. The cache memory 1540 typically has a faster response time than main memory 1522. As shown in FIG. 50A, the central processing unit 1521 communicates with various I/O devices 1530 via the local system bus 1550. Various buses may be used as the local system bus 1550, including a Video Electronics Standards Association (VESA) Local bus (VLB), an Industry Standard Architecture (ISA) bus, an Extended Industry Standard Architecture (EISA) bus, a MicroChannel Architecture (MCA) bus, a Peripheral Component Interconnect (PCI) bus, a PCI Extended (PCI-X) bus, a PCI-Express bus, or a NuBus. For embodiments in which an I/O device is a display device 1530c, the central processing unit 1521 may communicate with the display device 1530c through an Advanced Graphics Port (AGP). FIG. 50B depicts an embodiment of a computer 1500 in which the central processing unit 1521 communicates directly with I/O device 1530e. FIG. 50B also depicts an embodiment in which local busses and direct communication are mixed: the central processing unit 1521 communicates with I/O device 1530d using a local system bus 1550 while communicating with I/O device 1530e directly.

A wide variety of I/O devices 1530 may be present in the computing device 1500. Input devices include one or more keyboards 1530a, mice, trackpads, trackballs, microphones, and drawing tablets. Output devices include video display devices 1530c, speakers, and printers. An I/O controller 1523, as shown in FIG. 50A, may control the I/O devices. The I/O controller may control one or more I/O devices such as a keyboard 1530a and a pointing device 1530b, e.g., a mouse or optical pen.

Referring again to FIG. 50A, the computing device 1500 may support one or more removable media interfaces 1516, such as a floppy disk drive, a CD-ROM drive, a DVD-ROM drive, tape drives of various formats, a USB port, a Secure Digital or COMPACT FLASH™ memory card port, or any other device suitable for reading data from read-only media, or for reading data from, or writing data to, read-write media. An I/O device 1530 may be a bridge between the system bus 1550 and a removable media interface 1516.

The removable media interface 1516 may for example be used for installing software and programs. The computing device 1500 may further comprise a storage device 1528, such as one or more hard disk drives or hard disk drive arrays, for storing an operating system and other related software, and for storing application software programs. Optionally, a removable media interface 1516 may also be used as the storage device. For example, the operating system and the software may be run from a bootable medium, for example, a bootable CD.

In some embodiments, the computing device 1500 may comprise or be connected to multiple display devices 1530c, which each may be of the same or different type and/or form. As such, any of the I/O devices 1530 and/or the I/O controller 1523 may comprise any type and/or form of suitable hardware, software, or combination of hardware and software to support, enable or provide for the connection to, and use of, multiple display devices 1530c by the computing device 1500. For example, the computing device 1500 may include any type and/or form of video adapter, video card, driver, and/or library to interface, communicate, connect or otherwise use the display devices 1530c. In one embodiment, a video adapter may comprise multiple connectors to interface to multiple display devices 1530c. In other embodiments, the computing device 1500 may include multiple video adapters, with each video adapter connected to one or more of the display devices 1530c. In some embodiments, any portion of the operating system of the computing device 1500 may be configured for using multiple display devices 1530c. In other embodiments, one or more of the display devices 1530c may be provided by one or more other computing devices, connected, for example, to the computing device 1500 via a network. These embodiments may include any type of software designed and constructed to use the display device of another computing device as a second display device 1530c for the computing device 1500. One of ordinary skill in the art will recognize and appreciate the various ways and embodiments that a computing device 1500 may be configured to have multiple display devices 1530c.

A computing device 1500 of the sort depicted in FIG. 50A and FIG. 50B may operate under the control of an operating system, which controls scheduling of tasks and access to system resources. The computing device 1500 may be running any operating system, any embedded operating system, any real-time operating system, any open source operating system, any proprietary operating system, any operating systems for mobile computing devices, or any other operating system capable of running on the computing device and performing the operations described herein.

The computing device 1500 may be any workstation, desktop computer, laptop or notebook computer, server machine, handheld computer, mobile telephone or other portable telecommunication device, media playing device, gaming system, mobile computing device, or any other type and/or form of computing, telecommunications or media device that is capable of communication and that has sufficient processor power and memory capacity to perform the operations described herein. In some embodiments, the computing device 1500 may have different processors, operating systems, and input devices consistent with the device.

In other embodiments the computing device 1500 is a mobile device, such as a Java-enabled cellular telephone or personal digital assistant (PDA), a smart phone, a digital audio player, or a portable media player. In some embodiments, the computing device 1500 comprises a combination of devices, such as a mobile phone combined with a digital audio player or portable media player.

As shown in FIG. 50C, the central processing unit 1521 may comprise multiple processors P1, P2, P3, P4, and may provide functionality for simultaneous execution of instructions or for simultaneous execution of one instruction on more than one piece of data. In some embodiments, the computing device 1500 may comprise a parallel processor with one or more cores. In one of these embodiments, the computing device 1500 is a shared memory parallel device, with multiple processors and/or multiple processor cores, accessing all available memory as a single global address space. In another of these embodiments, the computing device 1500 is a distributed memory parallel device with multiple processors each accessing local memory only. In still another of these embodiments, the computing device 1500 has both some memory which is shared and some memory which may only be accessed by particular processors or subsets of processors. In still even another of these embodiments, the central processing unit 1521 comprises a multicore microprocessor, which combines two or more independent processors into a single package, e.g., into a single integrated circuit (IC). In one exemplary embodiment, depicted in FIG. 50D, the computing device 1500 includes at least one central processing unit 1521 and at least one graphics processing unit 1521′.

In some embodiments, a central processing unit 1521 provides single instruction, multiple data (SIMD) functionality, e.g., execution of a single instruction simultaneously on multiple pieces of data. In other embodiments, several processors in the central processing unit 1521 may provide functionality for execution of multiple instructions simultaneously on multiple pieces of data (MIMD). In still other embodiments, the central processing unit 1521 may use any combination of SIMD and MIMD cores in a single device.

A computing device may be one of a plurality of machines connected by a network, or it may comprise a plurality of machines so connected. FIG. 50E shows an exemplary network environment. The network environment comprises one or more local machines 1502a, 1502b (also generally referred to as local machine(s) 1502, client(s) 1502, client node(s) 1502, client machine(s) 1502, client computer(s) 1502, client device(s) 1502, endpoint(s) 1502, or endpoint node(s) 1502) in communication with one or more remote machines 1506a, 1506b, 1506c (also generally referred to as server machine(s) 1506 or remote machine(s) 1506) via one or more networks 1504. In some embodiments, a local machine 1502 has the capacity to function as both a client node seeking access to resources provided by a server machine and as a server machine providing access to hosted resources for other clients 1502a, 1502b. Although only two clients 1502 and three server machines 1506 are illustrated in FIG. 50E, there may, in general, be an arbitrary number of each. The network 1504 may be a local-area network (LAN), e.g., a private network such as a company Intranet, a metropolitan area network (MAN), or a wide area network (WAN), such as the Internet, or another public network, or a combination thereof.

The computing device 1500 may include a network interface 1518 to interface to the network 1504 through a variety of connections including, but not limited to, standard telephone lines, local-area network (LAN), or wide area network (WAN) links, broadband connections, wireless connections, or a combination of any or all of the above. Connections may be established using a variety of communication protocols. In one embodiment, the computing device 1500 communicates with other computing devices 1500 via any type and/or form of gateway or tunneling protocol such as Secure Socket Layer (SSL) or Transport Layer Security (TLS). The network interface 1518 may comprise a built-in network adapter, such as a network interface card, suitable for interfacing the computing device 1500 to any type of network capable of communication and performing the operations described herein. An I/O device 1530 may be a bridge between the system bus 1550 and an external communication bus.

According to one embodiment, the network environment of FIG. 50E may be a virtual network environment where the various components of the network are virtualized. For example, the various machines 1502 may be virtual machines implemented as a software-based computer running on a physical machine. The virtual machines may share the same operating system. In other embodiments, different operating system may be run on each virtual machine instance. According to one embodiment, a “hypervisor” type of virtualization is implemented where multiple virtual machines run on the same host physical machine, each acting as if it has its own dedicated box. Of course, the virtual machines may also run on different host physical machines.

Other types of virtualization are also contemplated, such as, for example, the network (e.g. via Software Defined Networking (SDN)). Functions, such as functions of the session border controller and other types of functions, may also be virtualized, such as, for example, via Network Functions Virtualization (NFV).

Although this invention has been described in certain specific embodiments, those skilled in the art will have no difficulty devising variations to the described embodiment, which in no way depart from the scope and spirit of the present invention. Furthermore, to those skilled in the various arts, the invention itself herein will suggest solutions to other tasks and adaptations for other applications. It is the applicant's intention to cover by claims all such uses of the invention and those changes and modifications which could be made to the embodiments of the invention herein chosen for the purpose of disclosure without departing from the spirit and scope of the invention. Thus, the present embodiments of the invention should be considered in all respects as illustrative and not restrictive, the scope of the invention to be indicated by the appended claims and their equivalents rather than the foregoing description.

What is claimed is:

1. A method for managing a contact center, the method comprising:
receiving, by a processor, a first plurality of communications from a server during a training period;
transmitting, by the processor, a pair of the communications to a device operated by a first contact center agent;
receiving, by the processor, a signal from the device operated by the first contact center agent indicating a selection, by the first contact center agent, of a ranking between the pair of the communications;
receiving, by the processor, a second plurality of communications from the server during a non-training period;
reorganizing, by the processor, the second plurality of communications based on the selection of the ranking between the pair of communications to generate a reorganized second plurality of communications; and
routing, by the processor during the non-training period, one or more of the reorganized second plurality of communications according to rank.

2. The method of claim 1, wherein the server corresponds to a social media platform.

3. The method of claim 1, further comprising storing, by the processor, the communications in a buffer.

4. The method of claim 1, further comprising storing, by the processor, the plurality of ranked pairs in a buffer based on a plurality of selections from a plurality of agents regarding a plurality of pairs of the communications.

5. The method of claim 1, wherein the signal comprises a ranked pair indicating the selection of the ranking between the pair of the communications.

6. The method of claim 5, further comprising calculating, by the processor, a weight vector based on the ranked pair.

7. The method of claim 6, further comprising reorganizing, by the processor, the second plurality of communications based on the weight vector.

8. The method of claim 1, further comprising routing, by the processor, a communication, from among the pair of communications, that corresponds to the selection of a higher ranking between the pair of the communications, to the device operated by the first contact center agent.

9. The method of claim 1, further comprising transmitting, by the processor, the pair of the communications to a device operated by a second contact center agent.

10. The method of claim 9, further comprising:
receiving, by the processor, a signal from the device operated by the second contact center agent indicating a selection, by the second contact center agent, of the ranking between the pair of the communications; and
overwriting, by the processor, the selection by the first contact center agent with the selection by the second contact center agent.

11. A system for managing a contact center, the system comprising:
a processor; and
a memory coupled to the processor, wherein the memory stores instructions that, when executed by the processor, cause the processor to:
receive a first plurality of communications from a server during a training period;
transmit a pair of the communications to a device operated by a first contact center agent;
receive a signal from the device operated by the first contact center agent indicating a selection, by the first contact center agent, of a ranking between the pair of the communications;
receive a second plurality of communications from the server during a non-training period;
reorganize the second plurality of communications based on the selection of the ranking between the pair of communications to generate a reorganized second plurality of communications; and
route, during the non-training period, one or more of the reorganized second plurality of communications according to rank.

12. The system of claim 11, wherein the server corresponds to a social media platform.

13. The system of claim 11, wherein the instructions further cause the processor to store the communications in a buffer.

14. The system of claim 11, wherein the instructions further cause the processor to store the plurality of ranked pairs in a buffer based on a plurality of selections from a plurality of agents regarding a plurality of pairs of the communications.

15. The system of claim 11, wherein the signal comprises a ranked pair indicating the selection of the ranking between the pair of the communications.

16. The system of claim 11, wherein the instructions further cause the processor to calculate a weight vector based on the ranked pair.

17. The system of claim 11, wherein the instructions further cause the processor to reorganize the second plurality of communications based on the weight vector.

18. The system of claim 11, wherein the instructions further cause the processor to route a communication, from among the pair of communications, that corresponds to the selection of a higher ranking between the pair of the communications, to the device operated by the first contact center agent.

19. The system of claim 11, wherein the instructions further cause the processor to:
transmit the pair of the communications to a device operated by a second contact center agent;
receive a signal from the device operated by the second contact center agent indicating a selection, by the second contact center agent, of the ranking between the pair of the communications; and
overwrite the selection by the first contact center agent with the selection by the second contact center agent.

20. A system for managing a contact center, the system comprising:
means for receiving a first plurality of communications from a server during a training period;
means for transmitting a pair of the communications to a device operated by a first contact center agent;
means for receiving a signal from the device operated by the first contact center agent indicating a selection, by the first contact center agent, of a ranking between the pair of the communications;
means for receiving a second plurality of communications from the server during a non-training period;
means for reorganizing the second plurality of communications based on the selection of the ranking between the pair of communications to generate a reorganized second plurality of communications; and
means for routing, during the non-training period, one or more of the reorganized second plurality of communications according to rank.
